(19) United States
(12) Patent Application Publication
(10) Pub. No.: US 2025/0147972 A1
(43) Pub. Date: May 8, 2025

(54) SENTIMENT-BASED LATENT SPACE VISUALIZATION FOR SEARCHES

(71) Applicant: Capital One Services, LLC, McLean, VA (US)

(72) Inventors: Taylor TURNER, Richmond, VA (US); Kenny BEAN, Herndon, VA (US)

(73) Assignee: Capital One Services, LLC, McLean, VA (US)

(21) Appl. No.: 18/502,858

(22) Filed: Nov. 6, 2023

(51) Int. Cl. G06F 16/2457; G06F 16/28; G06F 40/284; G06F 40/30

(52) U.S. Cl. CPC G06F 16/24578; G06F 16/24573; G06F 16/285; G06F 40/284; G06F 40/30

(57) ABSTRACT

A method and related system for visualizing search result information based on sentiment includes operations to retrieve sentiment scores associated with retrieved records associated with display scores and comprising values in a latent space, determining a centering sentiment based on the sentiment scores, and determining sentiment ranges and subranges based on the centering sentiment. The method further includes selecting a first record based on display scores of records within the first subrange, sending data comprising the sentiment range to a client device that causes the client device to present a visualization of a region bounded by the sentiment range. The visualization includes a first shape representing the first record positioned in a first subregion associated with a positive sentiment and a second shape representing a record within the second subrange positioned in a second subregion associated with a negative sentiment.

### SUMMARY

Modem information systems rely on sophisticated tools that may search through vast amounts of data to retrieve the most relevant or most popular documents, links, or other data. However, such searches may often result in search results which are directed along a single set of ideas, regardless of whether this idea is the most valid or accurate one.

Some embodiments may overcome these limitations or other technical limitations by using a system capable of generating a visualization of records along a sentiment scale featuring positive and negative sentiment scores. In some embodiments, the visualization region may be centered around a moving average sentiment but may be wide enough to show clusters in a latent space representing documents which indicate other sentiments. Some embodiments may first determine a set of sentiment scores for retrieved records that are retrieved via a query. Some embodiments may apply a sentiment analysis to text content of the records, where these records may be associated with display scores indicating likelihoods of displaying records in a ranked list of the query results. Some embodiments may then determine a weighted mean sentiment or other measure of central tendency for the sentiments by determining a set of products based on the set of sentiment scores and display scores. By determining the set of sentiment scores for a set of retrieved records and then determining a weighted mean sentiment based on those sets of sentiment scores, some embodiments may determine a centering sentiment for a visualization region in a latent space.

Some embodiments may then determine a sentiment range for the visualization region, with a sentiment range that may include different subranges that are determined from a population parameter and the weighted mean sentiment. In some embodiments, the population parameter may represent a total number of results to be represented in the visualization region, a percentage of the total search results, or some other value to control a number of records to be displayed in a visualization region. Some embodiments may restrict a first subrange to be indicative of positive sentiment scores and further restrict a second subrange to be indicative of negative sentiment scores. Some embodiments may then select, within each respective subrange, a respective record to be displayed upon an interaction with a visual representation of records in that respective subrange. Some embodiments may select which respective record to display or otherwise present based on a corresponding display score. For example, some embodiments may select, for a first subrange indicating a range of positive sentiment scores, a respective record based on a respective display score representing the most relevant or most popular record. Some embodiments may also select a most relevant or most popular link associated with a second subrange indicating a range of negative sentiment scores.

Some embodiments may further associate additional linked records with a selected record, where information from the additional linked records may be presented upon an interaction with the selected record or a shape representing the selected record in a user interface. Some embodiments may then send data that includes or otherwise indicates the sentiment range to a client device. The data may cause or otherwise help the client device present a visualization of a region defined by the sentiment range.

The client device, after receiving the data, may show a user interface (UI) that indicates a set of shapes representing search results. A first shape may indicate a first record representing a search result. The first shape may be positioned in a first subregion of the UI, where the first subregion can be associated with a positive sentiment. The UI can also show a second shape indicating a record of a second subset of records within the second subrange is positioned in a second subregion of the UI, where the second subregion can be associated with a negative sentiment. In some embodiments, an interaction (e.g., a tap, a mouse click, an API command simulating a user interaction) with the first shape may cause a presentation of a linked shape shown in connection with the first shape. Furthermore, the interaction with the linked shape may cause a presentation of content of the third record, such as an identifier, a stored link, text content, etc.

Various other aspects, features, and advantages will be apparent through the detailed description of this disclosure and the drawings attached hereto. It is also to be understood that both the foregoing general description and the following detailed description are examples and not restrictive of the scope of the invention.

### BRIEF DESCRIPTION OF THE DRAWINGS

Detailed descriptions of implementations of the present technology will be described and explained through the use of the accompanying drawings.

FIG. 1 illustrates an example system to initiate disjointed runtime environments for dependency applications, in accordance with some embodiments.

FIG. 2 illustrates an example set of user interfaces showing visualized latent spaces that are centered around a centering sentiment across two different time periods, in accordance with some embodiments.

FIG. 3 illustrates an example set of user interfaces showing a three-dimensional latent space that is centered around a centering sentiment, in accordance with some embodiments.

FIG. 4 is a flowchart of operations for an exemplary method of visualizing query results, in accordance with one or more embodiments.

The technologies described herein will become more apparent to those skilled in the art by studying the detailed description in conjunction with the drawings. Embodiments of implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

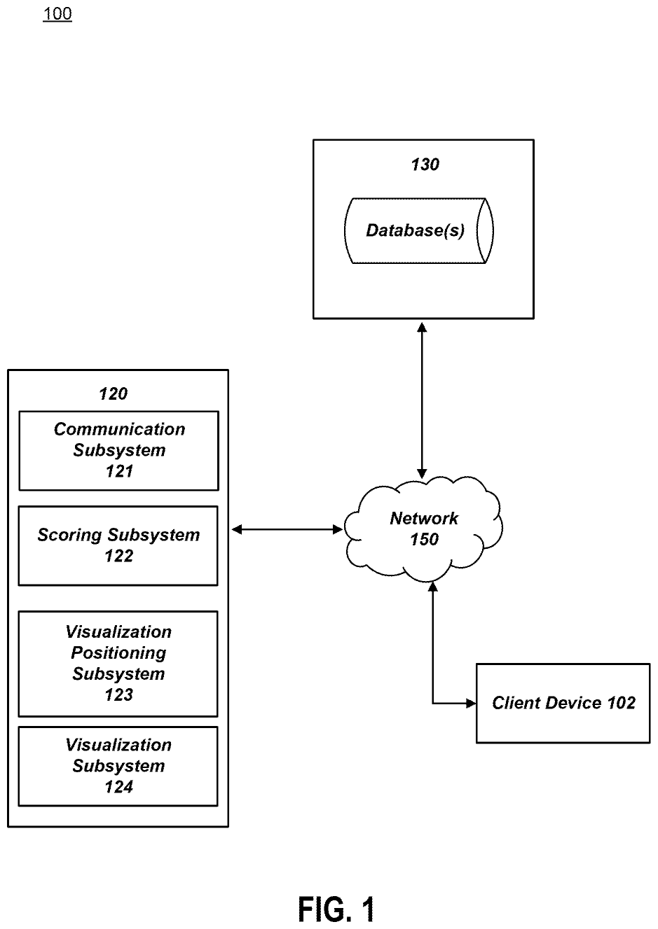

FIG. 1 illustrates an example system to initiate disjointed runtime environments for dependency applications, in accordance with some embodiments. A system 100 includes a client device 102. While shown as a laptop computer, it should be noted that the client device 102 may include other types of computing devices such as a desktop computer, a wearable headset, a smartwatch, another type of mobile computing device, etc. In some embodiments, the client device 102 may communicate with various other computing devices via a network 150, where the network 150 may include the internet, a local area network, a peer-to-peer network, etc. The client device 102 may send and receive messages through the network 150 to communicate with a set of servers 120, where the set of servers 120 may include a set of non-transitory storage media storing program instructions to perform one or more operations of subsystems 121-124. By performing such operations using one or more components shown in the system 100, some embodiments may provide visualizations of search results across a more diverse sentiment range while preserving information relevance and popularity.

While one or more operations are described herein as being performed by particular components of the system 100, those operations may be performed by other components of the system 100 in some embodiments. For example, one or more operations described in this disclosure as being performed by the set of servers 120 may instead be performed by the client device 102. Furthermore, some embodiments may communicate with an application programming interface (API) of a third-party service via the network 150 to perform various operations disclosed herein, such as determining a set of sentiment scores, selecting score subranges, transmitting data, or performing other operations described in this disclosure. For example, some embodiments may use an API to access a private network or the internet to retrieve records, documents, or other data.

In some embodiments, the set of computer systems and subsystems illustrated in FIG. 1 may include one or more computing devices having electronic storage or otherwise capable of accessing electronic storage, where the electronic storage may include the set of databases 130. The set of databases 130 may include values used to perform operations described in this disclosure. Data stored in the set of databases 130 may include prediction model parameters (e.g., weights or biases of a neural network, parameters of a random forest model, rule identifiers for a rules engine, etc.), sentiment scores, latent space values, records, data related to websites or other data accessible via Uniform Resource Locator (URL) link, or other data. For example, the records being retrieved by a query and a sentiment range that corresponds with a subset of the retrieved records may be stored in the set of databases 130.

In some embodiments, a communication subsystem 121 may retrieve information such as model parameters of a prediction model, obtain values for an explainability model, obtain predetermined explainability parameters, etc. For example, the communication subsystem 121 may crawl through a set of URL links provided by the client device 102 to collect data. The communication subsystem 121 may further send instructions to perform one or more actions or send data to other computing devices, such as the client device 102. For example, some embodiments may send data generated by the set of servers 120 to the client device 102 for visualizing a search result on the client device 102.

In some embodiments, a scoring subsystem 122 may perform operations to determine a set of sentiment scores for a set of records, documents, or other set of text data. For example, the scoring subsystem 122 may generate a set of sentiment scores for each record of a set of records retrieved from a database, where each record may represent content from a website or web application. Furthermore, the scoring subsystem 122 may generate multiple sentiment scores corresponding with different topics for a text data of a record or other text data.

The scoring subsystem 122 may use one or more machine learning models and datasets corresponding to those machine learning models to determine a sentiment of a record. For example, scoring subsystem 122 may use a trained neural network to determine topic-specific sentiments for a record, where the topic may be based on a query. The machine learning model used to determine sentiment may be implemented with one or more various types of neural network architecture, such as a recurrent neural network, a transformer neural network, a convolutional neural network, etc. For example, some embodiments may provide a transformer neural network of the scoring subsystem 122 with text content from a plurality of records to obtain one or more topic-specific sentiment scores for each record of the plurality of records. Alternatively, or additionally, the machine learning model may include other types of learning models, such as gradient-boosted trees, a naïve Bayes model, a random forest, etc.

The scoring subsystem 122 may also determine display scores for records based on factors other than sentiment. For example, the scoring subsystem 122 may determine a ranked list of query results for a query. The ranked list of query results may be ranked by a corresponding set of display scores, where each display score is determined as a function of a count of unique links to that record, a relevance score of the text content of the record to the query, a visit count associated with the record, etc. As discussed elsewhere in this disclosure, some embodiments may use the display scores of a cluster of records or another type of subset of records to determine which record to present in association with shapes in a search result visualization.

In some embodiments, a visualization positioning subsystem 123 may determine a visualization window size in a latent space or a sentiment score space. For example, some embodiments may determine that a visualization window size should range from 0.3 to 0.6 along a sentiment score having a domain ranging from 0.0 to 1.0. In some embodiments, the visualization positioning subsystem 123 may determine a full range for visualization based on a set of population parameters. For example, some embodiments may use a population percentage as a population parameter such that the total number of records indicated in a visualization window is depicted to include shapes corresponding with a total population that is equal to the population percentage or greater than the population percentage.

In some embodiments, the visualization positioning subsystem 123 may also be used to determine a set of subranges, where each respective subrange corresponds with a different cluster of records. For example, a first subrange of a sentiment range may span from 0.21 to 0.26 and may encompass a first cluster having 5,811 records. A second subrange of the sentiment range may span from 0.62 to 0.66. As used in this disclosure, a position or range in a sentiment range may be described as a positive sentiment, a neutral sentiment, or a negative sentiment. It should be understood that a negative sentiment score for a document indicates a degree of negativity distributed through the document or with regards to a specified topic. Therefore, if a sentiment score ranges from 0 to 1.0, a positive sentiment may be represented by any sentiment value greater than 0.55, and a neutral sentiment score may be any sentiment score within the sentiment range starting from 0.45 to 0.55. Some embodiments may first select a set of subranges and then determine an overall range and a sentiment range to be displayed in a user interface.

In some embodiments, the visualization positioning subsystem 123 may enforce the selection of at least one subrange indicated to be a subrange in a region representing negative sentiment scores and further enforce the selection of at least one subrange indicated to be a subrange in a region representing positive sentiment scores. By enforcing the determination of subranges in both positive and negative sentiment score ranges, where these sentiment score ranges are mapped to records retrieved by query results, some embodiments may provide a more diverse range of search results. In contrast, the presentation of query results in a way that does not consider sentiments for a topic (e.g., a query presentation that displays links and summaries of web pages based on a popularity of the web page or a number of links to the web page) may fail to display a diverse range of search results with respect to sentiment.

In some embodiments, the visualization positioning subsystem 123 may determine a centering sentiment for an initial view of a search result visualization. Some embodiments may determine the centering sentiment by calculating a weighted mean sentiment, where the weighted mean sentiment may represent a sum of products for each record to be represented in a search result. For example, some embodiments may determine the weighted mean sentiment based on the display scores for a set of records and their corresponding sentiment values, such that each respective record contributes a respective product value to the weighted mean sentiment, where the respective product is a product of a respective sentiment score of the respective record and a respective display score of the respective record.

In some embodiments, the visualization subsystem 124 may collect or generate a set of visualization data to be sent to the client device 102. When received by a display-capable device such as the client device 102, the set of visualization data generated by the visualization subsystem 124 may cause the display-capable device to present a visualization of a region in a sentiment dimension to present different shapes to represent different clusters centered around different sentiment subranges. For example, the set of visualization data may cause a user interface (UI) displayed on the client device 102 to show a first shape indicating a first record in a first subregion that is labeled with a positive sentiment score. For example, the first shape may be a circle in a two-dimensional space or a sphere in a three-dimensional space. The set of visualization data may further include data corresponding with a second shape indicating a second record in a second subregion that is labeled with a negative sentiment score. For example, the second shape may be another circle in a two-dimensional space or another sphere in a three-dimensional space.

In some embodiments, the visualization subsystem 124 may generate data that includes information about links between different records such that an interaction with a shape in a UI that represents a first record may directly cause the appearance of additional linked records in the same sentiment subrange assigned to the first record. For example, some embodiments may select a first record from a subset of records for display in a UI in relation to a first shape based on the corresponding display score of this selected record. Some embodiments may further determine a set of linked records with this first record based on a distance in latent space between the first record and other candidate records. After the client device 102 receives the visualization data, a UI of the client device 102 may be configured such that an interaction with the first shape associated with a first record will cause the presentation of one identifier of a linked record. By using a tiered system that first considers sentiment scores to group different records before determining similarities in latent space, some embodiments may provide both diverse and representative information in an efficient manner in comparison to a list-based presentation of a search result.

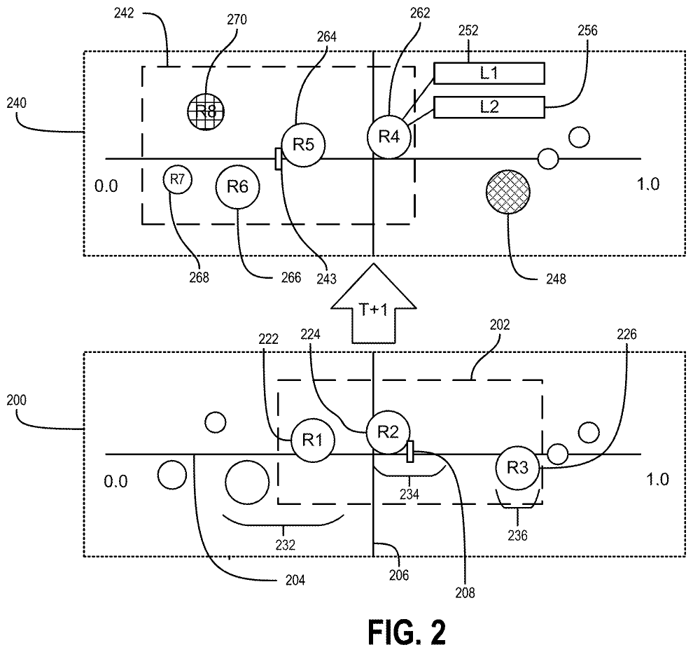

FIG. 2 illustrates an example set of UIs showing visualized latent spaces that are centered around a centering sentiment across two different time periods, in accordance with some embodiments. Some embodiments may generate a first visualization 200 in response to receiving a first query request. The first visualization 200 depicts a two-dimensional graph and includes a horizontal axis 204 and a vertical axis 206. The horizontal axis 204 may represent sentiment, and the vertical axis 206 may represent a dimension in a latent space or a value based on a set of dimensions in a latent space. In other embodiments, either of the axes may represent a degree of relevance to a topic, a second type of sentiment, etc.

The dashed box 202 represents an initial visualization to be displayed on a UI. The dashed box 202 includes a first shape 222, a second shape 224, and a third shape 226. The first visualization 200 may be centered around a first centering sentiment 208. In some embodiments, the portion of the first visualization 200 shown in the dashed box 202 may represent a search result, where each of the first shape 222, second shape 224, and third shape 226 may represent at least one record storing a document or other text content. As can be observed, records represented by the second shape 224 and the third shape 226 are shown as being associated with a positive sentiment score, while records represented by the first shape 222 are shown as being associated with a negative sentiment score.

Some embodiments may select records for each of the first shape 222, second shape 224, and third shape 226 based on a determination that the records of the clusters are within a set of sentiment subranges 232, 234, and 236. For example, some embodiments may determine records for the first shape 222 based on a determination that a first subset of records have sentiment scores within the first sentiment subrange 232. Some embodiments may determine records for the second shape 224 based on a determination that a second subset of records have sentiment scores within the second sentiment subrange 234. Some embodiments may determine records for the third shape 226 based on a determination that a third subset of records have sentiment scores within the third sentiment subrange 236.

As shown in the first visualization 200, some embodiments may display information associated with records for the first shape 222, the second shape 224, and the third shape 226. For example, the first shape 222 shows a first identifier for a first record, the second shape 224 shows a second identifier for a second record, and the third shape 226 shows a third identifier for a third record. Some embodiments may select which record to display in association with a shape based on a display score associated with the shape. For example, the first shape 222 may display “R1” as the identifier for a record identified by “R1,” where the displayed record is selected based on a display score associated with R1. In some embodiments, “R1” may be selected for display because record “R1” has the greatest display score out of all the other records represented by the first shape 222. Similarly, some embodiments may select a record “R2” for display in the second shape 224 and select a record “R3” in the third shape 226 based on the associated display scores for these records.

Some embodiments may generate a second visualization 240 in response to receiving a second query request after generating the first visualization 200, where an initial visualization to be displayed on a user interface is represented by the dashed box 242. The dashed box 242 includes a fourth shape 262, a fifth shape 264, a sixth shape 266, a seventh shape 268, and an eighth shape 270. Some embodiments may generate the second visualization 240 in response to a second query request made at a different time, where one or more records have been updated. As shown in the second visualization 240, data may be indicated as anomalous or verified, which may change the sentiment range used to define the size of the dashed box 242 or change the position of a second centering sentiment 243. For example, a computer system may receive an indication that a record represented by the ninth shape 248 was indicated as anomalous and, in response, reduce a display score associated with the record. Furthermore, a computer system may receive an indication that a record represented by the eighth shape 270 is verified and, in response, increase a display score associated with one or more records represented by the eighth shape 270.

Some embodiments may generate multiple visualizations of searches based on the same query text across different historical snapshots or intervals. For example, some embodiments may obtain the query text “wireless charging” and access a data structure to retrieve a first subset of records storing content and metadata associated with the content (e.g., site traffic, URLs, host domains, links to other webpages or records), where the data in the first subset of records was obtained in the term interval Jan. 1, 2020 to Jan. 4, 2020. Some embodiments may then use the same query text “wireless charging” to access the data structure to retrieve a second subset of records storing second content and metadata associated with the second content, where the data in the second subset of records was obtained a year earlier, between Jan. 1, 2019 to Jan. 4, 2020. Some embodiments may continue to retrieve subsets of records corresponding with data obtained at other durations with a one-year interval between each time until an insufficient amount of data for analysis is obtainable for a particular duration (e.g., the number of records retrieved by a search through a portion of the data structure associated with a particular year is less than a minimum threshold).

Some embodiments may concurrently display visualizations of each of the retrieved subsets of records corresponding with data obtained at different times. For example, some embodiments may display a first search result in a latent space representing records of data obtained in the month of February 2023, a second search result in the latent space representing records of data obtained in the month of February 2022, and a third search result in a latent space representing records of data obtained in the month of February 2021. In some embodiments, the time between collected data, the duration in which data is grouped together, or the minimum threshold may be changed. For example, some embodiments may receive a set of configuration parameters and, based on the configuration parameters, change a request to present visualizations based on “data collected in the 7-days duration starting on February 1 for each year” to present visualizations based on “data collected in the 7-days duration starting on February 1 every two years.”

Some embodiments may generate a set of linked shapes in response to an interaction with a shape in the second visualization 240. For example, a UI may be configured such that an interaction (e.g., a tap of a finger, a click of a mouse, another type of UI element selection) with the fourth shape 262 causes the presentation of a first linked shape 252 and a second linked shape 256. In some embodiments, each linked shape of the pair of linked shapes 252 and 256 displays a set of linked records that are associated with the record “R4” displayed in the fourth shape 262. In some embodiments, the association between a record displayed in a first shape and a record shown in a linked shape may be established based on a distance in latent space between the records.

As can be seen by the position of the fourth shape 262, some embodiments may be configured to enforce the display of at least one record associated with a positive sentiment and display at least one record associated with a negative sentiment. For example, some embodiments may configure the generation of the visualization region represented by the dashed box 242 such that the fourth shape 262 is displayed as a set of records associated with positive sentiment scores despite all the other records represented by shapes in the dashed box 242 being associated with negative sentiment scores. By presenting a search result based on sentiment and enforcing the display of records that have a positive sentiment and the display of records having a negative sentiment, some embodiments may be able to present information in a broader, more comprehensive manner.

In some embodiments, the changes to the visualization window represented by the dashed box 202 and the dashed box 242 over time may be animated. For example, some embodiments may show, in a UI, a shift between the first centering sentiment 208 and the second centering sentiment 243. Some embodiments may also animate the changes of the sentiment score range from the dashed box 202 to the dashed box 242.

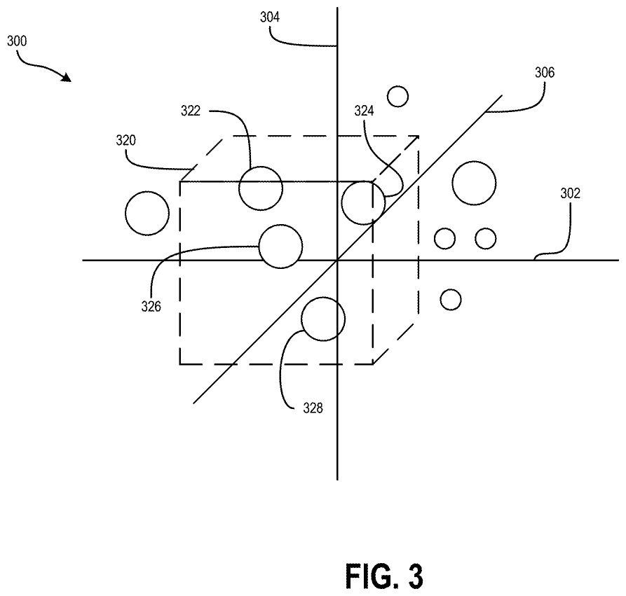

FIG. 3 illustrates an example set of user interfaces showing a three-dimensional latent space that is centered around a centering sentiment, in accordance with some embodiments. Some embodiments may generate a three-dimensional plot 300 in response to receiving a query request. The three-dimensional plot 300 includes a first axis 302, a second axis 304, and a third axis 306. In some embodiments, the first axis 302 may represent a first sentiment domain, the second axis 304 may represent a second sentiment domain, and the third axis 306 may represent a second topic relevancy domain.

The dashed cube 320 may represent a visualization boundary in the three-dimensional space of the three-dimensional plot 300. Some embodiments may determine the dimensions of the dashed cube 320 based on sentiment ranges, where some embodiments may further determine a relevancy score range by normalizing topic relevancy scores and retrieving predetermined boundaries for topic relevancy to determine topic relevancy clusters. The dashed cube 320 bounds a first shape 322, a second shape 324, a third shape 326, and a fourth shape 328. While the shapes 322, 324, 326, and 328 are shown as spheres, other types of shapes may be used. Each of the shapes 322, 324, 326, and 328 may represent a single record or multiple records of a search result. As discussed elsewhere, some embodiments may sort the records of the search result based on one or more sentiment domains, and presenting information in a three-dimensional form segmented by sentiment may provide a more comprehensive view of information regarding a topic.

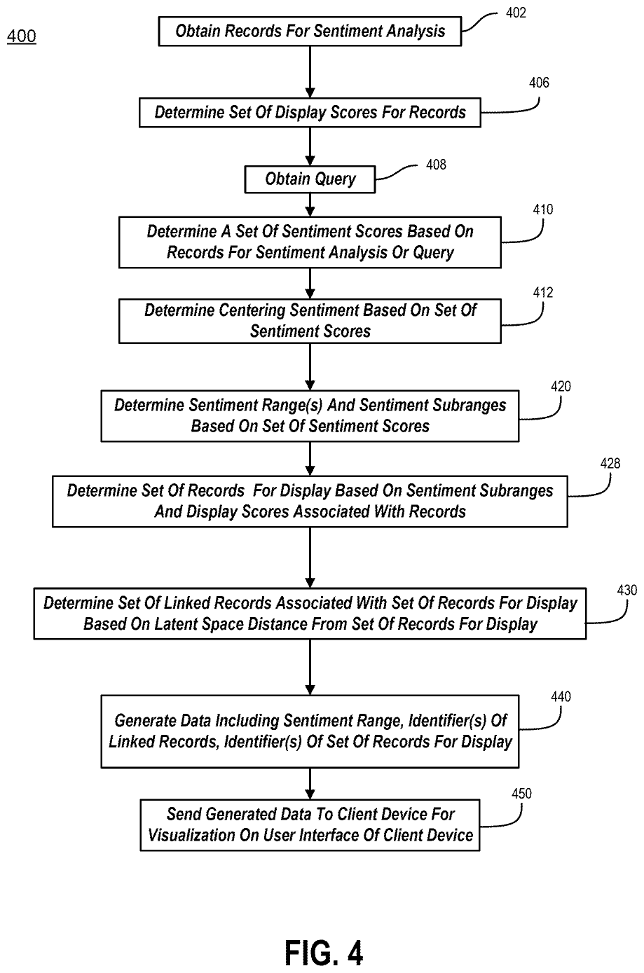

FIG. 4 is a flowchart of operations for an exemplary method of visualizing query results, in accordance with one or more embodiments. Some embodiments may obtain records for sentiment analysis, as indicated by block 402. Some embodiments may obtain a set of records by accessing the internet to retrieve publicly accessible website, web page, or web application data. For example, some embodiments may retrieve records by retrieving text content of a web page via a hyperlink and then store the text content of the web page, the URL, and metadata associated with the hyperlink (e.g., a domain, a last date of update, a registration date, etc.) in a record. Furthermore, some embodiments may detect links to a web page, website, or other data source and store these links as links to the record storing data obtained from the web page, website, or other data source. For example, some embodiments may detect that a web page has 6,000 links to a website hyperlink and, in response, update a database to indicate that 6,000 links direct to a record of content provided by the website hyperlink. Some embodiments may use the count of links directed to a record to determine a display score for the record (e.g., by adding the link count with a count of visits to the corresponding web page used to generate the record and using the sum as a display score).

Some embodiments may generate tokens, latent space vectors, or other information based on content originally obtained from a hyperlink. For example, as described elsewhere, some embodiments may provide text content of a record to a natural language model to retrieve an initial set of topics and an initial set of sentiment scores related to the initial set of topics. Some embodiments may then update one or more fields of the record to include the set of topics and the initial set of sentiment scores in association. Once these generated values are stored, some embodiments may receive a new query that causes a computer system to search a database storing the record and retrieve the record with the initial set of sentiment scores.

After obtaining a set of records, some embodiments may analyze the set of records in a latent space. Some embodiments may then generate a multidimensional vector in a latent space for each record. For example, after receiving a set of 1,000 records by crawling through an initial set of search results, some embodiments may then generate a multidimensional vector having 64 elements for each of the 1,000 records, where the dimensions of the 64 elements may represent a latent space.

Some embodiments may perform a set of clustering operations using a clustering model to determine a set of record clusters based on the latent space values of the records. Various types of clustering operations may be performed, such as a density-based clustering (DBC) operation. Furthermore, some embodiments may perform operations to accommodate the possibility that different topics may have different meaningful standards for clustering density or other clustering parameters. For example, some embodiments may obtain a set of clustering parameters (e.g., a density parameter) corresponding with a specific topic or some other type of value and configure a clustering model based on the set of clustering parameters. Some embodiments may then identify different record clusters based on the topic-specific set of clustering parameters by using the configured clustering model. As described elsewhere in this disclosure, if a first record of a record cluster is selected for display in a UI, a second record of the record cluster may be linked to the first record such that the second record may also be presented in the UI based on a distance in the latent space.

Some embodiments may determine a set of display scores for the records, as indicated by block 406. A display score for a record may be used as a weight to determine the likelihood that a record should be displayed to a user relative to other records. Some embodiments may determine a display score as a function output based on one or more parameters, such as a count of links, an indicated length of content in the record, an indicated popularity of the record (e.g., a site traffic of a website, a count of clicks on a link of the record, other popularity-related metadata associated with content of the record, etc.), an indicated count of links directed to the content of the record, etc.

Some embodiments may receive information indicating that the record, website, or other data source holding data used to populate the record is verified by a trusted verification system. Some embodiments indicate the record of the verified data when sending visualization data to a client device or performing other visualization-related operations such that a representation of the record may be made more visually distinct relative to other records. For example, some embodiments may generate data that, after being received by a client device, causes the client device to change the color of a shape representing the verified record. Alternatively, some embodiments may increase or otherwise modify a display score for a candidate record in response to a determination that the candidate record is verified. Furthermore, some embodiments may increase the weight of a cluster corresponding with the record such that parameters of a visualization region will be modified to include a shape representing the candidate record.

When determining a display score, some embodiments may receive an indication that one or more records has been classified as anomalous and, in response, decrease a corresponding display score of those one or more anomalous records. For example, some embodiments may receive an indication that a candidate record has been classified as an anomalous record and, in response, decrease a display score of the candidate record. Furthermore, some embodiments may determine that one or more other records direct to this candidate record via one or more identified links (e.g., a URL hyperlink pointing to the candidate record or the URL storing data from which the candidate record was generated). Some embodiments may then determine that this subset of records that include one or more links directing to the candidate record is also an anomalous subset of records based on their set of associations with the candidate record. Some embodiments may then reduce a set of display scores corresponding with this anomalous subset of records.

Some embodiments may obtain a query, as indicated by block 408. Some embodiments may obtain a query provided by a client device. For example, a user may enter text for a query into a client device, where the client device may then send the query to a server. Some embodiments may parse the query and perform preprocessing operations on the query. Some embodiments may determine a set of tokens based on the query, where each token may be a word, part of a word, character, symbol, etc. Some embodiments may then use a token, a sequence of tokens, or some other combination of tokens as a query parameter for a database query.

Some embodiments may then determine a set of topics based on the tokens. Some embodiments may use a token or combination of tokens as a topic based on a match between the token or combination of tokens and a known topic from a listed set of topics. Some embodiments may use topic detection algorithms to determine a topic based on the query. For example, some embodiments may use latent Dirichlet analysis (LDA) to determine a set of topics based on an obtained query by comparing the obtained query with other received queries. Alternatively, or additionally, some embodiments may use clustering methods to perform topic classification. For example, some embodiments may determine a set of vectors based on a set of tokens for a query using an encoder neural network and determine, in a latent space, a relation with one or more known topics in the latent space to assign the one or more topics to the query. After determining a topic, some embodiments may determine a set of topic-specific sentiment scores as described elsewhere in this disclosure.

Some embodiments may determine a set of sentiment scores based on the obtained records or the obtained query, as indicated by block 410. Some embodiments may use a lexicon-based sentiment analysis. For example, some embodiments may determine a sentiment score using an AFINN lexical model, such as an AFINN lexical model using the AFINN-en-165.txt lexicon. Alternatively, or additionally, some embodiments may use a machine learning model to determine a sentiment. Some embodiments may use a set of preprocessing operations to preprocess text content of a record and then provide the preprocessed content to a neural network to determine a sentiment. For example, some embodiments may tokenize text content of a set of records to generate a vocabulary and encode the text content based on the generated vocabulary. Some embodiments may then use the encodings of the text content as inputs for a machine learning model to determine a sentiment score for each record of the set of records to determine the machine learning model.

Some embodiments may compute different types of sentiments corresponding with different sentiment lexicons. For example, some embodiments may train a first machine learning model to detect sentiment based on whether text content is “positive” or “negative” based on a first vocabulary and train a second machine learning model to detect sentiment based on whether the sentiment is “excited” or “calm” based on a second vocabulary. Some embodiments may then determine a first subset of sentiment scores associated with the first vocabulary for a set of obtained records, where sentiment score values of the first subset of sentiment scores represent whether a text document is “positive” or “negative.” Some embodiments may further determine a second subset of sentiment scores associated with the second vocabulary for a set of obtained records, where sentiment score values of the second subset of sentiment scores represent whether a text document is “excited” or “calm.”

As described elsewhere in this disclosure, some embodiments may determine a set of topics and then determine a set of topic-specific sentiment scores associated with those topics to a record. For example, a computer system may use a topic-based sentiment analysis model, such as a recurrent neural network model trained to recognize sentiment for specific topics, to determine a topic-specific sentiment score. Various types of machine learning models may be used to perform topic-based sentiment analysis, such as a convolutional neural network, transformer neural network, or some other type of neural network. For example, a query may be assigned to the topic “efficiency” and “attention mechanisms.” Some embodiments may then use a topic-based sentiment analysis model to assign the first sentiment score “0.92” to the topic “efficiency” and assign a second sentiment score “0.62” to the topic “attention mechanisms.” Some embodiments may then perform visualization operations or other operations described elsewhere in this disclosure for one or more of the different sentiment spaces for one or more topics.

Some embodiments may determine a centering sentiment based on the set of sentiment scores, as indicated by block 412. Some embodiments may determine a centering sentiment by determining a measure of central tendency of the sentiment scores for the records obtained via a query, such as a mean sentiment score, a median sentiment score, etc. Some embodiments may apply weights to the sentiment scores of records based on a corresponding set of display scores or other values related to the records. For example, some embodiments may multiply each respective sentiment score of each respective record of a set of records by a respective visit count of the respective record to determine the respective product of sentiment score and visit count. Some embodiments may then determine a centering sentiment by determining a sum of this set of products and dividing the sum by a range representing the maximum and minimum sentiments when computing a centering sentiment. Furthermore, other means of determining a centering sentiment based on sentiment scores of records can be performed. For example, some embodiments may use weights representing display scores instead of visit counts when determining a centering sentiment.

Some embodiments may determine a set of sentiment ranges and a set of sentiment subranges based on the set of sentiment scores, as indicated by block 420. Some embodiments may determine the set of sentiment ranges based on a maximum and minimum sentiment score. For example, some embodiments may determine a maximum and minimum sentiment score and set this maximum and minimum sentiment score as the sentiment range. Alternatively, some embodiments may determine a sentiment range based on a centering sentiment and a preset value, such as a preset range in sentiment space, a preset fraction of records to be encompassed, etc. For example, some embodiments may determine a centering sentiment and then select a maximum value and a minimum value for the sentiment range based on a pre-set sentiment range threshold surrounding the centering sentiment. Furthermore, in some embodiments, the sentiment range may be configured such that at least one record representing a negative sentiment in the sentiment space and at least one record in a positive sentiment in the sentiment space will be represented.

Some embodiments may select sentiment subranges based on a predefined or predicted subsets of records (e.g., records that are defined to be part of a same cluster). For example, some embodiments may select a sentiment position of a sentiment subrange based on a centering sentiment corresponding with a first record, where the first record is determined to be part of a first cluster having 30 other records. Some embodiments may then determine the size of the sentiment subrange corresponding with the first record to encompass the sentiment values of the other 30 records. Alternatively, or additionally, some embodiments may use a pre-defined value to determine the size of sentiment subranges. For example, after selecting a first positive sentiment position as the size of the sentiment subrange, some embodiments may determine the size of the sentiment subrange by setting the upper and lower bounds of the subrange by a present value of 0.05.

Some embodiments may determine a set of records in the sentiment subranges for display based on display scores associated with the records, as indicated by block 428. As described elsewhere, some embodiments may determine a set of record clusters based on latent space values of the retrieved records by performing a clustering operation (e.g., a DBC operation). Each cluster in the latent space may then be further segmented in a sentiment space to form different clusters in a mixed semantic latent space to form one or more intersection record subsets. Each record in an intersection record subset for a cluster may then be defined as being clustered in a latent space and further being within a defined sentiment subregion. Some embodiments may then select a record of the intersection record subset (“intersection record”) for display. For example, some embodiments may, for each respective cluster of the different clusters segmented by their corresponding sentiments in the sentiment subranges, select a respective intersection record for display in a visualization based on an associated respective display score of the respective intersection record.

Some embodiments may determine a set of linked records associated with the set of records for display based on a set of latent space distances from the set of records for display, as indicated by block 430. A candidate record may be determined to be a linked record that is associated with a record selected for display based on a determination that the candidate record is in the same sentiment subrange as the record selected for display and some criteria indicating a subject matter similarity with the record selected for display. As described elsewhere in this disclosure, some embodiments may perform clustering operations that assign different records with each other based on their positions in a latent space. Some embodiments may then select a nearest record in the latent space as a linked record to the record selected for display. In some embodiments, other records also in a same cluster or other identified subset including the record selected for display may also be associated with the record selected for display. For example, some embodiments may determine a set of distances, such as a set of Euclidean distances, from a selected record in latent space. Some embodiments may then select, as a linked record, the candidate record associated with the least distance from a record selected for display. As described elsewhere, this association between the nearest record to a first record selected for display may be conveyed in data transmitted from a server to a client device. The UI of the client device may then display an identifier or other information of the linked record in response to an interaction with a UI element representing a record selected for display.

In some embodiments, a distance used to determine whether a record should be selected as a linked record associated with a first record may be a distance in a mixed semantic latent space. A mixed semantic latent space may be a multidimensional space that combines the latent space of a language model space and sentiment scores. In some embodiments, a mixed semantic latent space may include only one dimension representing a single semantic score type. Alternatively, some embodiments may use a mixed semantic latent space that includes multiple dimensions representing different types of semantic scores, such as a first semantic score type corresponding with a first topic and a second semantic score type corresponding with a second topic. Some embodiments may determine a mixed semantic latent space distance between a pair of records based on a set of differences between latent space values and semantic scores between the pair of records. For example, some embodiments may determine the set of differences and then compute the root mean square value for the set of differences to compute a Euclidean distance in mixed semantic latent space for use as a mixed semantic latent space distance. By using a mixed semantic latent space distance to determine whether or not a record should be linked with a record selected for display, some embodiments may provide a degree of consistency in sentiment in addition to topic consistency or vocabulary consistency.

Some embodiments may generate data and send data to a client device, the data including the sentiment range and a set of identifiers for the set of linked records and the set of records for display, as indicated by 440. When generating data for a visualization of a search result, some embodiments may generate different shapes for different records or different record clusters. For example, some embodiments may determine that a first subset of records is labeled as being part of a first cluster in a sentiment subrange and update visualization data that causes a client device to generate a first shape representing the first subset of records. In some embodiments, the first shape may be made larger in one or more dimensions based on values related to the first subset of records. For example, if the first shape is depicted as a circle, the size of the circle may be determined based on a count of records in the subset, a count of the popularity of the records in the subset, a sum of display scores of records in the subset, or some other value associated with the records of the subset.

In some embodiments, an anomalous record in a cluster may change the color or some other property of a shape generated to represent the anomalous record or cluster including the anomalous record. For example, if a circle is displayed in a UI to represent a first cluster and a determination is made that a record of the first cluster is an anomalous record, some embodiments may generate or update visualization data such that the circle is displayed with a different color than clusters consisting of nonanomalous records.

After receiving the generated data at a client device, the client device may update a UI on a display of the client device for visualization on the UI of the client device. In some embodiments, the sentiment range conveyed in visualization data may include a visual boundary to indicate the extent of an initial visualization region. For example, the sentiment range may be represented by a red-line boundary, where the intersection between the boundary and any axes may indicate a maximum value and a minimum value of the sentiment range. Alternatively, or additionally, some embodiments may provide additional boundaries for sentiment subranges.

The operations of each method presented in this disclosure are intended to be illustrative and non-limiting. It is contemplated that the operations or descriptions of FIG. 4 may be used with any other embodiment of this disclosure. In addition, the operations and descriptions described in relation to FIG. 4 may be done in alternative orders or in parallel to further the purposes of this disclosure. For example, each of these operations may be performed in any order, in parallel, or simultaneously to reduce lag or increase the speed of a computer system or method. In some embodiments, the methods may be accomplished with one or more additional operations not described, and/or without one or more of the operations discussed. Additionally, the order in which the processing operations of the methods are illustrated (and described below) is not intended to be limiting.

As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety (i.e., the entire portion), of a given item (e.g., data) unless the context clearly dictates otherwise. Furthermore, a “set” may refer to a singular form or a plural form, such that a “set of items” may refer to one item or a plurality of items.

In some embodiments, the operations described in this disclosure may be implemented in a set of processing devices (e.g., a digital processor, an analog processor, a digital circuit designed to process information, an analog circuit designed to process information, a state machine, and/or other mechanisms for electronically processing information). The processing devices may include one or more devices executing some or all of the operations of the methods in response to instructions stored electronically on a set of non-transitory, machine-readable media, such as an electronic storage medium. Furthermore, the use of the term “media” may include a single medium or combination of multiple media, such as a first medium and a second medium. A set of non-transitory, machine-readable media storing instructions may include instructions included on a single medium or instructions distributed across multiple media. The processing devices may include one or more devices configured through hardware, firmware, and/or software to be specifically designed for the execution of one or more of the operations of the methods. For example, it should be noted that one or more of the devices or equipment discussed in relation to FIG. 1 could be used to perform one or more of the operations described for descriptions corresponding to FIG. 2-4.

It should be noted that the features and limitations described in any one embodiment may be applied to any other embodiment herein, and a flowchart or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

In some embodiments, the various computer systems and subsystems illustrated in FIG. 1 may include one or more computing devices that are programmed to perform the functions described herein. The computing devices may include one or more electronic storages (e.g., a set of databases accessible to one or more applications depicted in the system 100), one or more physical processors programmed with one or more computer program instructions, and/or other components. For example, the set of databases may include a relational database such as a PostgreSQL™ database or MySQL database. Alternatively, or additionally, the set of databases or other electronic storage used in this disclosure may include a non-relational database, such as a Cassandra™ database, MongoDB™ database, Redis database, Neo4j™ database, Amazon Neptune™ database, etc.

The computing devices may include communication lines or ports to enable the exchange of information with a set of networks (e.g., a network used by the system 100) or other computing platforms via wired or wireless techniques. The network may include the internet, a mobile phone network, a mobile voice or data network (e.g., a 5G or Long-Term Evolution (LTE) network), a cable network, a public switched telephone network, or other types of communications networks or combination of communications networks. A network described by devices or systems described in this disclosure may include one or more communications paths, such as Ethernet, a satellite path, a fiber-optic path, a cable path, a path that supports internet communications (e.g., IPTV), free-space connections (e.g., for broadcast or other wireless signals), Wi-Fi, Bluetooth, near field communication, or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Each of these devices described in this disclosure may also include electronic storages. The electronic storages may include non-transitory storage media that electronically stores information. The storage media of the electronic storages may include one or both of (i) system storage that is provided integrally (e.g., substantially non-removable) with servers or client computing devices, or (ii) removable storage that is removably connectable to the servers or client computing devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). An electronic storage may store software algorithms, information determined by the processors, information obtained from servers, information obtained from client computing devices, or other information that enables the functionality as described herein.

The processors may be programmed to provide information processing capabilities in the computing devices. As such, the processors may include one or more of a digital processor, an analog processor, a digital circuit designed to process information, an analog circuit designed to process information, a state machine, and/or other mechanisms for electronically processing information. In some embodiments, the processors may include a plurality of processing units. These processing units may be physically located within the same device, or the processors may represent the processing functionality of a plurality of devices operating in coordination. The processors may be programmed to execute computer program instructions to perform functions described herein of subsystems 121-124 or other subsystems. The processors may be programmed to execute computer program instructions by software; hardware; firmware; some combination of software, hardware, or firmware; and/or other mechanisms for configuring processing capabilities on the processors.

It should be appreciated that the description of the functionality provided by the different subsystems described herein is for illustrative purposes, and is not intended to be limiting, as any of subsystems 121-124 may provide more or less functionality than is described. For example, one or more of subsystems 121-124 may be eliminated, and some or all of its functionality may be provided by other ones of subsystems 121-124. As another example, additional subsystems may be programmed to perform some or all of the functionality attributed herein to one of subsystems 121-124 described in this disclosure.

With respect to the components of computing devices described in this disclosure, each of these devices may receive content and data via input/output (I/O) paths. Each of these devices may also include processors and/or control circuitry to send and receive commands, requests, and other suitable data using the I/O paths. The control circuitry may comprise any suitable processing, storage, and/or I/O circuitry. Further, some or all of the computing devices described in this disclosure may include a user input interface and/or user output interface (e.g., a display) for use in receiving and displaying data. In some embodiments, a display such as a touchscreen may also act as a user input interface. It should be noted that in some embodiments, one or more devices described in this disclosure may have neither user input interface nor displays and may instead receive and display content using another device (e.g., a dedicated display device such as a computer screen and/or a dedicated input device such as a remote control, mouse, voice input, etc.). Additionally, one or more of the devices described in this disclosure may run an application (or another suitable program) that performs one or more operations described in this disclosure.

Although the present invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the scope of the appended claims. For example, it is to be understood that the present invention contemplates that, to the extent possible, one or more features of any embodiment may be combined with one or more features of any other embodiment.

As used throughout this application, the word “may” is used in a permissive sense (i.e., meaning having the potential to), rather than the mandatory sense (i.e., meaning must). The words “include,” “including,” “includes,” and the like mean including, but not limited to. As used throughout this application, the singular forms “a,” “an,” and “the” include plural referents unless the context clearly indicates otherwise. Thus, for example, reference to “an element” or “a element” includes a combination of two or more elements, notwithstanding the use of other terms and phrases for one or more elements, such as “one or more.” The term “or” is non-exclusive (i.e., encompassing both “and” and “or”), unless the context clearly indicates otherwise. Terms describing conditional relationships (e.g., “in response to X, Y,” “upon X, Y,” “if X, Y,” “when X, Y,” and the like) encompass causal relationships in which the antecedent is a necessary causal condition, the antecedent is a sufficient causal condition, or the antecedent is a contributory causal condition of the consequent (e.g., “state X occurs upon condition Y obtaining” is generic to “X occurs solely upon Y” and “X occurs upon Y and Z”). Such conditional relationships are not limited to consequences that instantly follow the antecedent obtaining, as some consequences may be delayed, and in conditional statements, antecedents are connected to their consequents (e.g., the antecedent is relevant to the likelihood of the consequent occurring). Statements in which a plurality of attributes or functions are mapped to a plurality of objects (e.g., a set of processors performing steps/operations A, B, C, and D) encompass all such attributes or functions being mapped to all such objects and subsets of the attributes or functions being mapped to subsets of the attributes or functions (e.g., both/all processors each performing steps/operations A-D, and a case in which processor 1 performs step/operation A, processor 2 performs step/operation B and part of step/operation C, and processor 3 performs part of step/operation C and step/operation D), unless otherwise indicated. Further, unless otherwise indicated, statements that one value or action is “based on” another condition or value encompass both instances in which the condition or value is the sole factor and instances in which the condition or value is one factor among a plurality of factors.

Unless the context clearly indicates otherwise, statements that “each” instance of some collection has some property should not be read to exclude cases where some otherwise identical or similar members of a larger collection do not have the property (i.e., each does not necessarily mean each and every). Limitations as to the sequence of recited steps should not be read into the claims unless explicitly specified (e.g., with explicit language like “after performing X, performing Y”) in contrast to statements that might be improperly argued to imply sequence limitations (e.g., “performing X on items, performing Y on the X'ed items”) used for purposes of making claims more readable rather than specifying a sequence. Statements referring to “at least Z of A, B, and C,” and the like (e.g., “at least Z of A, B, or C”), refer to at least Z of the listed categories (A, B, and C) and do not require at least Z units in each category. Unless the context clearly indicates otherwise, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Furthermore, unless indicated otherwise, updating an item may include generating the item or modifying an existing time. Thus, updating a record may include generating a record or modifying the value of an already-generated value.

Unless the context clearly indicates otherwise, ordinal numbers used to denote an item do not define the item's position. For example, an item that may be a first item of a set of items even if the item is not the first item to have been added to the set of items or is otherwise indicated to be listed as the first item of an ordering of the set of items. Thus, for example, if a set of items is sorted in a sequence from “item 1,” “item 2,” and “item 3,” a first item of a set of items may be “item 2” unless otherwise stated.

The present techniques will be better understood with reference to the following enumerated embodiments:

1. A method comprising: retrieving a set of sentiment scores associated with retrieved records associated with display scores and comprising values in a latent space; determining a centering sentiment based on the set of sentiment scores and the display scores; determining a sentiment range comprising a first subrange and a second subrange based on the centering sentiment; selecting a first record based on display scores of records within the first subrange; and sending data comprising the sentiment range to a client device, the data causing the client device to present a visualization of a region bounded by the sentiment range, the visualization comprising: a first shape representing the first record is positioned in a first subregion associated with a positive sentiment; second shape representing a record within the second subrange is positioned in a second subregion associated with a negative sentiment.
2. The method of embodiment 1, wherein an interaction with the first shape causes a presentation of a linked shape.
3. The method of any of embodiments 2, wherein an interaction with the linked shape causes a presentation of content of a third record determined based on a set of distances in the latent space between the first record and the third record.
4. A method comprising: determining a set of sentiment scores for retrieved records that are retrieved via a query by applying sentiment analysis to text content of the records, wherein the records are associated with display scores indicating likelihoods of displaying the records in a ranked list of query results; determining a weighted mean sentiment by determining a set of products based on the set of sentiment scores and the display scores; determining a sentiment range comprising a first subrange and a second subrange based on a population parameter and the weighted mean sentiment, wherein the first subrange comprises positive sentiment scores, and wherein the second subrange comprises negative sentiment scores, and wherein a count of the records defined by the population parameter is within the sentiment range; selecting, for representation in a user interface, a first record of a first subset of records within the first subrange by ranking display scores of the first subset of records; associating the first record with a linked record based on a set of distances in a latent space of the retrieved records between the first record and the linked record; and sending data comprising the sentiment range to a client device, the data causing the client device to present a visualization of a region defined by the sentiment range, the visualization comprising: a first shape indicating the first record is positioned in a first subregion that is labeled with a positive sentiment score; a second shape indicating a record of a second subset of records within the second subrange is positioned in a second subregion labeled with a negative sentiment score; and an interaction with the first shape causes a presentation of a linked shape shown in connection with the first shape, wherein an interaction with the linked shape causes a presentation of content of the linked record.
5. A method comprising: determining a set of sentiment scores based on retrieved records that are retrieved via a query, wherein the retrieved records are associated with display scores and comprise values in a latent space; determining a centering sentiment based on the set of sentiment scores and the display scores; determining a sentiment range comprising a first subrange and a second subrange based on a population parameter and the centering sentiment, wherein the first subrange comprises positive sentiment scores, and wherein the second subrange comprises negative sentiment scores; selecting a first record by ranking display scores of a first subset of records within the first subrange; associating the first record with a third record based on a distance in the latent space between the first record and the third record; and sending data comprising the sentiment range to a client device, the data causing the client device to present a visualization of a region bounded by the sentiment range, the visualization comprising: a first shape indicating the first record is positioned in a first subregion associated with a positive sentiment; a second shape indicating a record of a second subset of records within the second subrange is positioned in a second subregion associated with a negative sentiment; and an interaction with the first shape causes a presentation of a linked shape shown in connection with the first shape, wherein an interaction with the linked shape causes a presentation of content of the third record.
6. The embodiment of any of embodiments 1 to 5, further comprising: obtaining a query comprising a set of tokens; and determining a set of topics based on the set of tokens, wherein: the set of sentiment scores comprises a set of topic-specific sentiment scores; and determining the set of sentiment scores comprises determining the set of sentiment scores by providing text of the retrieved records to a neural network model.
7. The embodiment of any of embodiments 1 to 6, wherein associating the first record with the third record comprises: determining a set of Euclidean distances in latent space between latent space values of the first record and latent space values of other records of the first subset of records; and selecting, as the third record, a nearest record in latent space based on the set of Euclidean distances.
8. The embodiment of any of embodiments 1 to 7, wherein the distance is a mixed semantic latent space distance, the method comprising determining the mixed semantic latent space distance based on a first set of differences between latent space values of the first record and latent space values of other records of the first subset of records, and a second set of differences between sentiment scores of the other records of the first subset of records.
9. The embodiment of any of embodiments 1 to 8, wherein: the set of sentiment scores comprises a first subset of sentiment scores associated with a first vocabulary and a second subset of sentiment scores associated with a second vocabulary; the centering sentiment is a first centering sentiment; the sentiment range is a first sentiment range; determining the set of sentiment scores comprises: determining the first subset of sentiment scores based on matches between the first vocabulary and tokens of the retrieved records; determining the second subset of sentiment scores based on matches between the second vocabulary and the tokens of the retrieved records; determining the first centering sentiment comprises determining the first centering sentiment based on the first subset of sentiment scores; and the method further comprises: determining a second centering sentiment based on the second subset of sentiment scores; and determining a second sentiment range based on the second centering sentiment and the population parameter, wherein the region is bounded by the second sentiment range.
10. The embodiment of any of embodiments 1 to 9, further comprising: receiving an indication that a candidate record of the retrieved records is anomalous; reducing a display score of the candidate record in response to receiving the indication; determining an anomalous subset of records based on a set of associations between the anomalous subset of records and the candidate record; and reducing a set of display scores of the anomalous subset of records.
11. The embodiment of any of embodiments 1 to 10, further comprising: receiving an indication that a candidate record of the retrieved records is verified; and increasing a display score of the candidate record in response to receiving the indication that the candidate record is verified.
12. The embodiment of any of embodiments 1 to 11, further comprising: determining a set of record clusters based on latent space values of the retrieved records by performing density-based clustering; and determining the first subset of records by: determining a first cluster of the set of record clusters based on the first subrange, where at least one record of the first cluster is within the first subrange; and selecting an intersection record subset by selecting a record that is a part of the first cluster and is within the first subrange, wherein an intersection record of the intersection record subset is the first record.
13. The method of embodiment 12, further comprising: obtaining the query; determining a topic based on the query; determining a density parameter based on the query, wherein performing density-based clustering operation comprises using the density parameter to configure the density-based clustering operation.
14. The embodiment of any of embodiments 1 to 13, wherein the retrieved records are retrieved via a query, the operations further comprising: retrieving text content of a web page via a hyperlink; providing the text content to a language model to retrieve an initial set of topics and an initial set of sentiment scores related to the initial set of topics; populating a database to comprise the text content and the initial set of sentiment scores; and searching the database based on the query to obtain the retrieved records, wherein the retrieved records comprises the initial set of sentiment scores.
15. The embodiment of any of embodiments 1 to 14, further comprising: determining a count of links to the first record stored in other records of the retrieved records; determining a first display score of the first record based on the count of the links.
16. The embodiment of any of embodiments 1 to 15, further comprising: receiving an indication that a candidate record of the retrieved records is an anomalous record; in response to receiving the indication, updating the data to display a fourth shape representing the anomalous record, wherein the fourth shape is presented with a color that is different from a color of the first shape.
17. The embodiment of any of embodiments 1 to 16, further comprising: receiving an indication that a candidate record of the retrieved records is verified; in response to receiving the indication, updating the data to modify the centering sentiment or the sentiment range to comprise a sentiment score of the candidate record.
18. The embodiment of any of embodiments 1 to 17, the operations further comprising:
obtaining text content of the first record; generating a summarization associated with the first record by providing the text content to a transformer neural network; and providing the summarization to the client device, wherein the interaction with the first shape causes a presentation of the summarization.
   19. The embodiment of any of embodiments 1 to 18, the operations further comprising:
obtaining a query; determining the retrieved records based on the query; determining a set of clustering parameters based on the query; configuring a clustering model based on the set of clustering parameters; and clustering the retrieved records using the clustering model to determine a first cluster of records, wherein the first cluster of records comprises the first record, and wherein selecting the first record comprises selecting the first record based on the first cluster of records.
   20. The embodiment of any of embodiments 1 to 19, wherein the visualization comprises a visual boundary indicating the sentiment range.
   21. The embodiment of any of embodiments 1 to 20, wherein the retrieved records are retrieved via a query, and wherein the centering sentiment is a first centering sentiment, and wherein the sentiment range is a first sentiment range, the operations further comprising: retrieving a second set of sentiment scores associated with second records retrieved via the query, wherein the second records are associated with second display scores; determining a second centering sentiment based on the second set of sentiment scores and the second display scores; determining a second sentiment range comprising a third subrange and a fourth subrange based on the centering sentiment; and displaying an indication of a difference between the first centering sentiment and the second centering sentiment or of a difference between the first sentiment range and the second sentiment range.
   22. The embodiment of embodiment 21, wherein the visualization displays an animation indicating a transition from the first centering sentiment to the second centering sentiment or a transition from the first sentiment range to the second sentiment range.
   23. One or more tangible, non-transitory, machine-readable media storing instructions that, when executed by a set of processors, cause the set of processors to effectuate operations comprising those of any of embodiments 1 to 22.
   24. A system comprising: a set of processors and a set of media storing computer program instructions that, when executed by the set of processors, cause the set of processors to effectuate operations comprising those of any of embodiments 1 to 22.

What is claimed is:

1. A system for determining a visualization region when visualizing records in a sentiment score range featuring positive and negative sentiments, the system comprising one or more processors and comprising one or more non-transitory, machine-readable media storing program instructions that, when executed by the one or more processors, perform operations comprising:
determining a set of sentiment scores for retrieved records that are retrieved via a query by applying sentiment analysis to text content of the records, wherein the records are associated with display scores indicating likelihoods of displaying the records in a ranked list of query results;
determining a weighted mean sentiment by determining a set of products based on the set of sentiment scores and the display scores;
determining a sentiment range comprising a first subrange and a second subrange based on a population parameter and the weighted mean sentiment, wherein the first subrange comprises positive sentiment scores, and wherein the second subrange comprises negative sentiment scores, and wherein a count of the records defined by the population parameter is within the sentiment range;
selecting, for representation in a user interface, a first record of a first subset of records within the first subrange by ranking display scores of the first subset of records;
associating the first record with a linked record based on a set of distances in a latent space of the retrieved records between the first record and the linked record; and
sending data comprising the sentiment range to a client device, the data causing the client device to present a visualization of a region defined by the sentiment range, the visualization comprising:
a first shape indicating the first record is positioned in a first subregion that is labeled with a positive sentiment score; and
a second shape indicating a record of a second subset of records within the second subrange is positioned in a second subregion labeled with a negative sentiment score, wherein an interaction with the first shape causes a presentation of a linked shape shown in connection with the first shape, and wherein an interaction with the linked shape causes a presentation of content of the linked record.

2. A method comprising:
determining a set of sentiment scores based on retrieved records that are retrieved via a query, wherein the retrieved records are associated with display scores and comprise values in a latent space;
determining a centering sentiment based on the set of sentiment scores and the display scores;
determining a sentiment range comprising a first subrange and a second subrange based on a population parameter and the centering sentiment, wherein the first subrange comprises positive sentiment scores, and wherein the second subrange comprises negative sentiment scores;
selecting a first record by ranking display scores of a first subset of records within the first subrange;
associating the first record with a third record based on a distance in the latent space between the first record and the third record; and
sending data comprising the sentiment range to a client device, the data causing the client device to present a visualization of a region bounded by the sentiment range, the visualization comprising:
a first shape indicating the first record is positioned in a first subregion associated with a positive sentiment;
a second shape indicating a record of a second subset of records within the second subrange is positioned in a second subregion associated with a negative sentiment, wherein an interaction with the first shape causes a presentation of a linked shape shown in connection with the first shape, wherein an interaction with the linked shape causes a presentation of content of the third record.

3. The method of claim 2, further comprising:
obtaining a query comprising a set of tokens; and
determining a set of topics based on the set of tokens, wherein:
the set of sentiment scores comprises a set of topic-specific sentiment scores; and
determining the set of sentiment scores comprises determining the set of sentiment scores by providing text of the retrieved records to a neural network model.

4. The method of claim 2, wherein associating the first record with the third record comprises:
determining a set of Euclidean distances in latent space between latent space values of the first record and latent space values of other records of the first subset of records; and
selecting, as the third record, a nearest record in latent space based on the set of Euclidean distances.

5. The method of claim 2, wherein the distance is a mixed semantic latent space distance, the method comprising determining the mixed semantic latent space distance based on a first set of differences between latent space values of the first record and latent space values of other records of the first subset of records, and a second set of differences between sentiment scores of the other records of the first subset of records.

6. The method of claim 2, wherein:
the set of sentiment scores comprises a first subset of sentiment scores associated with a first vocabulary and a second subset of sentiment scores associated with a second vocabulary;
the centering sentiment is a first centering sentiment;
the sentiment range is a first sentiment range;
determining the set of sentiment scores comprises:
determining the first subset of sentiment scores based on matches between the first vocabulary and tokens of the retrieved records;
determining the second subset of sentiment scores based on matches between the second vocabulary and the tokens of the retrieved records;
determining the first centering sentiment comprises determining the first centering sentiment based on the first subset of sentiment scores; and
the method further comprises:
determining a second centering sentiment based on the second subset of sentiment scores; and
determining a second sentiment range based on the second centering sentiment and the population parameter, wherein the region is bounded by the second sentiment range.

7. The method of claim 2, further comprising:
receiving an indication that a candidate record of the retrieved records is anomalous;
reducing a display score of the candidate record in response to receiving the indication;
determining an anomalous subset of records based on a set of associations between the anomalous subset of records and the candidate record; and
reducing a set of display scores of the anomalous subset of records.

8. The method of claim 2, further comprising:
receiving an indication that a candidate record of the retrieved records is verified; and
increasing a display score of the candidate record in response to receiving the indication that the candidate record is verified.

9. The method of claim 2, further comprising:
determining a set of record clusters based on latent space values of the retrieved records by performing density-based clustering; and
determining the first subset of records by:
determining a first cluster of the set of record clusters based on the first subrange, where at least one record of the first cluster is within the first subrange; and
selecting an intersection record subset by selecting a record that is a part of the first cluster and is within the first subrange, wherein an intersection record of the intersection record subset is the first record.

10. The method of claim 9, further comprising:
obtaining the query;
determining a topic based on the query;
determining a density parameter based on the query, wherein performing a density-based clustering operation comprises using the density parameter to configure the density-based clustering operation.

11. One or more non-transitory, machine-readable media storing program instructions that, when executed by one or more processors, performs operations comprising:
retrieving a set of sentiment scores associated with retrieved records associated with display scores and comprising values in a latent space;
determining a centering sentiment based on the set of sentiment scores and the display scores;
determining a sentiment range comprising a first subrange and a second subrange based on the centering sentiment;
selecting a first record based on display scores of records within the first subrange; and
sending data comprising the sentiment range to a client device, the data causing the client device to present a visualization of a region bounded by the sentiment range, the visualization comprising:
a first shape representing the first record is positioned in a first subregion associated with a positive sentiment;
a second shape representing a record within the second subrange is positioned in a second subregion associated with a negative sentiment, wherein an interaction with the first shape causes a presentation of a linked shape, and wherein an interaction with the linked shape causes a presentation of content of a third record determined based on a set of distances in the latent space between the first record and the third record.

12. The one or more non-transitory, machine-readable media of claim 11, wherein the retrieved records are retrieved via a query, the operations further comprising:
retrieving text content of a web page via a hyperlink;
providing the text content to a language model to retrieve an initial set of topics and an initial set of sentiment scores related to the initial set of topics;
populating a database to comprise the text content and the initial set of sentiment scores; and
searching the database based on the query to obtain the retrieved records, wherein the retrieved records comprise the initial set of sentiment scores.

13. The one or more non-transitory, machine-readable media of claim 11, further comprising:
determining a count of links to the first record stored in other records of the retrieved records;
determining a first display score of the first record based on the count of the links.

14. The one or more non-transitory, machine-readable media of claim 11, further comprising:
receiving an indication that a candidate record of the retrieved records is an anomalous record;
in response to receiving the indication, updating the data to display a fourth shape representing the anomalous record, wherein the fourth shape is presented with a color that is different from a color of the first shape.

15. The one or more non-transitory, machine-readable media of claim 11, further comprising:
receiving an indication that a candidate record of the retrieved records is verified;
in response to receiving the indication, updating the data to modify the centering sentiment or the sentiment range to comprise a sentiment score of the candidate record.

16. The one or more non-transitory, machine-readable media of claim 11, the operations further comprising:
obtaining text content of the first record;
generating a summarization associated with the first record by providing the text content to a transformer neural network; and
providing the summarization to the client device, wherein the interaction with the first shape causes a presentation of the summarization.

17. The one or more non-transitory, machine-readable media of claim 11, the operations further comprising:
obtaining a query;
determining the retrieved records based on the query;
determining a set of clustering parameters based on the query;
configuring a clustering model based on the set of clustering parameters; and
clustering the retrieved records using the clustering model to determine a first cluster of records, wherein the first cluster of records comprises the first record, and wherein selecting the first record comprises selecting the first record based on the first cluster of records.

18. The one or more non-transitory, machine-readable media of claim 11, wherein the visualization comprises a visual boundary indicating the sentiment range.

19. The one or more non-transitory, machine-readable media of claim 11, wherein the retrieved records are retrieved via a query, and wherein the centering sentiment is a first centering sentiment, and wherein the sentiment range is a first sentiment range, the operations further comprising:
retrieving a second set of sentiment scores associated with second records retrieved via the query, wherein the second records are associated with second display scores;
determining a second centering sentiment based on the second set of sentiment scores and the second display scores;
determining a second sentiment range comprising a third subrange and a fourth subrange based on the centering sentiment; and
displaying an indication of a difference between the first centering sentiment and the second centering sentiment or of a difference between the first sentiment range and the second sentiment range.

20. The one or more non-transitory, machine-readable media of claim 19, wherein the visualization displays an animation indicating a transition from the first centering sentiment to the second centering sentiment or a transition from the first sentiment range to the second sentiment range.
